(19) United States
(12) Patent Application Publication
(10) Pub. No.: US 2025/0358910 A1
(43) Pub. Date: Nov. 20, 2025

(54) COOKING APPLIANCE WITH IMAGE ANALYSIS BASED MODE SELECTION

(71) Applicant: Haier US Appliance Solutions, Inc., Wilmington, DE (US)

(72) Inventors: Jinmo Chong, Seoul (KR); MyungGeon Chung, Seoul (KR)

(21) Appl. No.: 18/669,043

(22) Filed: May 20, 2024

(51) Int. Cl. H05B 6/64; F24C 7/02; F24C 7/08; H05B 6/68

(52) U.S. Cl. CPC H05B 6/6447; F24C 7/02; F24C 7/08; H05B 6/687

(57) ABSTRACT

A cooking appliance includes a cabinet defining a cooking chamber, a heating assembly, a camera, and a controller in operable communication with the heating assembly and the camera. A method of operating the cooking appliance includes initializing a cooking operation of the cooking appliance, capturing a first image of a food item inside the cooking chamber using the camera in response to initializing the cooking operation, and determining one or more characteristics of the food item from the first image. The method further includes adjusting the cooking operation in response to the determined one or more characteristics of the food item and performing the adjusted cooking operation.

### FIELD OF THE INVENTION

The present subject matter relates generally to cooking appliances, and more particularly to image analysis in cooking appliances for selecting modes.

### BACKGROUND OF THE INVENTION

Kitchen appliances, such as microwave appliances, can be used by consumers to perform tasks such as heating or cooking food. Generally, microwave appliances include a cabinet that defines a cooking chamber for receipt of food items for cooking. In order to provide selective access to the cooking chamber and to contain food items and cooking energy (e.g., microwaves) during a cooking operation, a door is further included that is typically pivotally mounted to the cabinet. During use, a magnetron can generate microwave radiation or microwaves that are directed specifically to the cooking chamber. The microwave radiation is typically able to heat and cook food items within the cooking chamber faster than would be possible with conventional cooking methods using direct or indirect heating methods. Moreover, since microwave appliances are often smaller than other appliances (e.g., a conventional baking oven) within a kitchen, microwave appliances are often preferable for heating relatively small portions or amounts of food.

However, certain states of food items may benefit from specific cooking or heating modes. Accordingly, a microwave appliance capable of detecting states of food items would be advantageous in the art.

### BRIEF DESCRIPTION OF THE INVENTION

Aspects and advantages of the invention will be set forth in part in the following description, or may be obvious from the description, or may be learned through practice of the invention.

In one example aspect of the present disclosure, a method of operating a microwave appliance is provided. The microwave appliance includes a cabinet defining a cooking chamber, a heating assembly, a camera, and a controller in operable communication with the heating assembly and the camera. The method includes initializing a cooking operation of the microwave appliance, capturing a first image of a food item inside the cooking chamber using the camera in response to initializing the cooking operation, and determining one or more characteristics of the food item from the first image. The method further includes adjusting the cooking operation in response to the determined one or more characteristics of the food item and performing the adjusted cooking operation.

In another example aspect of the present disclosure, a cooking appliance is provided. The cooking appliance includes a cabinet defining a cooking chamber, a heating assembly positioned in the cabinet and a camera positioned in the cabinet. A controller is in operable communication with the heating assembly and the camera. The controller is configured to initialize a cooking operation of the microwave appliance, capture a first image of a food item inside the cooking chamber using the camera in response to initializing the cooking operation, and determine one or more characteristics of the food item from the first image. The controller is also configured to adjust the cooking operation in response to the determined one or more characteristics of the food item and perform the adjusted cooking operation.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a microwave appliance according to example embodiments of the present disclosure.

FIG. 2 provides a side schematic view of the example microwave of FIG. 1.

FIG. 3 provides a flow chart illustrating a method of operating a microwave appliance according to example embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

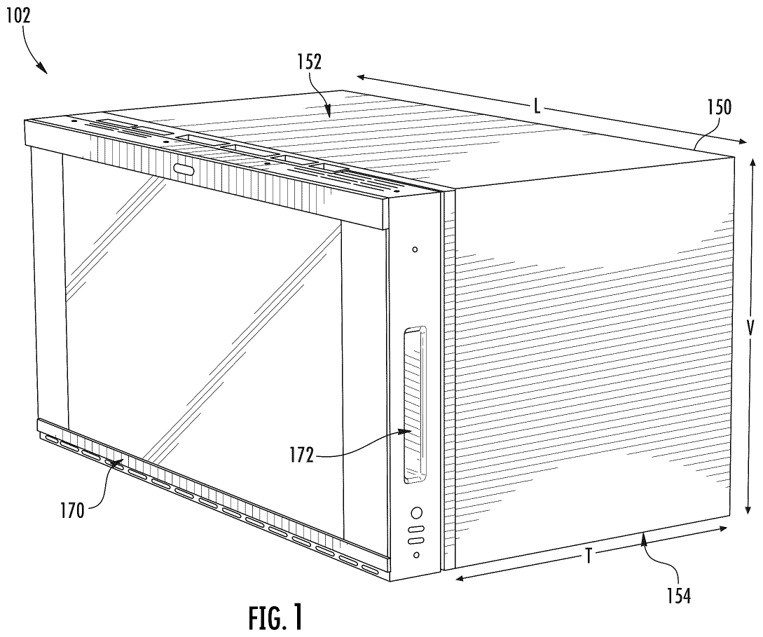

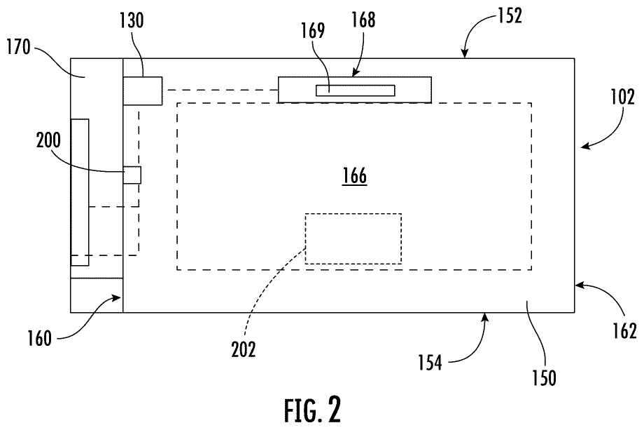

Turning to the figures, FIGS. 1 and 2 provide various views of a microwave appliance 102. Microwave appliance 102 is generally configured to heat articles (e.g., food or beverages) within a cooking chamber 166 using electromagnetic radiation. Microwave appliance 102 may include various components which operate to produce electromagnetic radiation, as is generally understood. For example, microwave appliance 102 may include a heating assembly 168 having a magnetron 169 (e.g., a cavity magnetron), a high voltage transformer (not shown), a high voltage capacitor (not shown), and a high voltage diode (not shown), as is understood. The transformer may provide energy from a suitable energy source (such as an electrical outlet) to the magnetron. The magnetron may convert the energy to electromagnetic radiation, specifically microwave radiation. The capacitor generally connects the magnetron and transformer, such as via high voltage diode, to a chassis. Microwave radiation produced by the magnetron may be transmitted through a waveguide to cooking chamber 166.

According to alternative embodiments, microwave appliance 102 may include one or more heating assemblies/elements, such as electric resistance heating elements, gas burners, other microwave heating elements, halogen heating elements, or suitable combinations thereof, positioned within cooking chamber 166 for heating cooking chamber 166 and food items positioned therein.

Microwave appliance 102 includes a cabinet 150. Cabinet 150 generally extends between a top end 152 and a bottom end 154 in the vertical direction V, and between a front end 160 and a rear end 162 in the transverse direction T. Cabinet 150 may also generally define cooking chamber 166. Microwave appliance 102 further includes a door assembly 170 that is movably mounted (e.g., rotatably attached) to cabinet 150 in order to permit selective access to cooking chamber 166. Specifically, door assembly 170 can move between an open position (not pictured) and a closed position (e.g., FIG. 1). The open position permits access to cooking chamber 166 while the closed position restricts access to cooking chamber 166. Except as otherwise indicated, with respect to the directions (e.g., the vertical direction V, the lateral direction L, and the transverse direction T), the door assembly 170 is described in the closed position. A handle 172, e.g., a pocket handle as illustrated in FIG. 1, or any other suitable form of handle, may be mounted to or formed on door assembly 170 to assist a user with opening and closing door assembly 170. As an example, a user can pull on handle 172 to open or close door assembly 170 and access or cover cooking chamber 166. Additionally, or alternatively, microwave appliance 102 may include a door release button (not pictured) that disengages or otherwise pushes open door assembly 170 when depressed.

Microwave appliance 102 may include a controller 130 that facilitates operation of microwave appliance 102. Controller 130 may be mounted within cabinet 150 or may be positioned and integrated in any other suitable manner.

In some embodiments, controller 130 includes one or more memory devices and one or more processors. The processors can be any combination of general or special purpose processors, CPUs, or the like that can execute programming instructions or control code associated with operation of microwave appliance 102. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 130 may be constructed without using a processor, for example, using a combination of discrete analog or digital logic circuitry (such as switches, amplifiers, integrators, comparators, flip-flops, AND gates, and the like) to perform control functionality instead of relying upon software. Furthermore, it should be noted that controller 130 may be capable of and may be operable to perform any methods, method steps, or portions of methods as disclosed hereinbelow. For example, in some embodiments, methods disclosed hereinbelow may be embodied in programming instructions stored in the memory and executed by controller 130.

As may be generally seen in FIG. 2, a camera assembly, e.g., a camera 200, may be positioned within cooking chamber 166. Camera 200 may generally be located in any suitable location within cabinet 150, such that food items, such as food item 202, may be visible to camera 200. In general, camera 200 may be configured to connect with controller 130 of microwave appliance 102. For example, camera 200 may be wirelessly connected to controller 130 of microwave appliance 102 over any suitable wireless connection, such as wireless radio, WI-FI®, BLUETOOTH®, ZIGBEE®, laser, infrared, and any other suitable device or interface. Generally, camera 200 may be a video camera or a digital camera with an electronic image sensor (e.g., a charge coupled device (CCD) or a CMOS sensor). When assembled, camera 200 is in communication (e.g., electric, or wireless communication) with controller 130 such that controller 130 may receive a signal from camera 200 corresponding to images captured by camera 200. Camera 200 may be configured to capture images of cooking chamber 166 (e.g., an interior of cabinet 150), and controller 130 may conduct “image analysis” of the images as will be explained further hereinbelow.

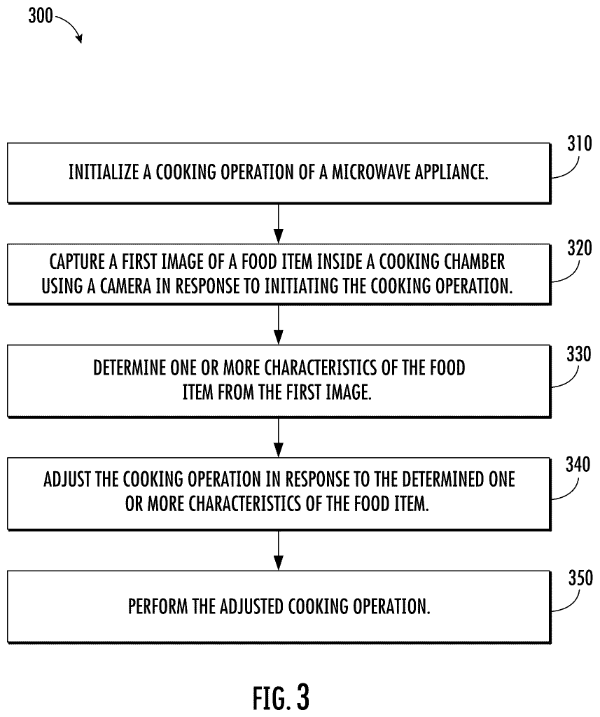

Referring now to FIG. 3, a flow diagram of one embodiment of a method 300 of operating microwave appliance 102 is illustrated in accordance with aspects of the present subject matter. In general, method 300 will be described herein with reference to the embodiments of microwave appliance 102 above with reference to FIGS. 1 and 2. However, it should be appreciated by those of ordinary skill in the art that the disclosed method 300 may generally be utilized in association with apparatuses and systems, e.g., cooking appliances, such as such as wall oven appliances, range appliances, over-the-range microwave appliances, or countertop microwave appliances, having any other suitable configuration, such as any suitable heating assemblies (e.g., gas burners, convection heating elements, resistive heating elements, etc.) configured to heat food items within the appliance. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

According to example embodiments of the present subject matter, method 300, as will be explained hereinbelow, may include obtaining one or more images of food item(s). Although the term “image” is used herein, it should be appreciated that according to example embodiments, camera 200 may take any suitable number or sequence of two-dimensional images, videos, or other visual representations of the food item(s). For example, the one or more images may include a video feed or series of sequential static images obtained by camera 200 that may be transmitted to the controller 130 (e.g., as a data signal) for analysis or other manipulation. These obtained images may vary in number, frequency, angle, field-of-view, resolution, detail, etc.

In general, method 300 may include analyzing the one or more images to identify characteristics of the food items. According to example embodiments, this image analysis may use any suitable image processing technique, image recognition process, etc. As used herein, the terms “image analysis” and the like may be used generally to refer to any suitable method of observation, analysis, image decomposition, feature extraction, image classification, etc. of one or more images, videos, or other visual representations of an object. As explained in more detail below, this image analysis may include the implementation of image processing techniques, image recognition techniques, or any suitable combination thereof. In this regard, the image analysis may use any suitable image analysis software or algorithm to constantly or periodically monitor the food item(s). It should be appreciated that this image analysis or processing may be performed locally (e.g., by controller 130) or remotely (e.g., by uploading image data to a remote server).

Specifically, the analysis of the one or more images may include implementation of an image processing algorithm. As used herein, the terms “image processing” and the like are generally intended to refer to any suitable methods or algorithms for analyzing images that do not rely on artificial intelligence or machine learning techniques (e.g., in contrast to the machine learning image recognition processes described below). For example, the image processing algorithm may rely on image differentiation, e.g., such as a pixel-by-pixel comparison of two sequential images. This comparison may help identify substantial differences between the sequentially obtained images, e.g., to identify movement, the presence of a particular object, the existence of a certain condition, etc. For example, one or more reference images may be obtained when a particular condition exists, and these references images may be stored for future comparison with images obtained during appliance operation. Similarities and/or differences between the reference image and the obtained image may be used to extract useful information for improving appliance performance.

According to example embodiments, image processing may include blur detection algorithms that are generally intended to compute, measure, or otherwise determine the amount of blur in an image. For example, these blur detection algorithms may rely on focus measure operators, the Fast Fourier Transform along with examination of the frequency distributions, determining the variance of a Laplacian operator, or any other methods of blur detection known by those having ordinary skill in the art. In addition, or alternatively, the image processing algorithms may use other suitable techniques for recognizing or identifying items or objects, such as edge matching or detection, divide-and-conquer searching, greyscale matching, histograms of receptive field responses, or another suitable routine. Other image processing techniques are possible and within the scope of the present subject matter. The processing algorithm may further include measures for isolating or eliminating noise in the image comparison, e.g., due to image resolution, data transmission errors, inconsistent lighting, or other imaging errors. By eliminating such noise, the image processing algorithms may improve accurate object detection, avoid erroneous object detection, and isolate the important object, region, or pattern within an image.

In addition to the image processing techniques described above, the image analysis may include utilizing artificial intelligence (“AI”), such as a machine learning image recognition process, a neural network classification module, any other suitable artificial intelligence (AI) technique, and/or any other suitable image analysis techniques, examples of which will be described in more detail below. Moreover, each of the example image analysis or evaluation processes described below may be used independently, collectively, or interchangeably to extract detailed information regarding the images being analyzed to facilitate performance of one or more methods described herein or to otherwise improve appliance operation. According to example embodiments, any suitable number and combination of image processing, image recognition, or other image analysis techniques may be used to obtain an accurate analysis of the obtained images.

In this regard, the image recognition process may use any suitable artificial intelligence technique, for example, any suitable machine learning technique, or for example, any suitable deep learning technique. According to an example embodiment, the image recognition process may include the implementation of a form of image recognition called region based convolutional neural network (“R-CNN”) image recognition. Generally speaking, R-CNN may include taking an input image and extracting region proposals that include a potential object or region of an image. In this regard, a “region proposal” may be one or more regions in an image that could belong to a particular object or may include adjacent regions that share common pixel characteristics. A convolutional neural network is then used to compute features from the region proposals and the extracted features will then be used to determine a classification for each particular region.

According to still other embodiments, an image segmentation process may be used along with the R-CNN image recognition. In general, image segmentation creates a pixel-based mask for each object in an image and provides a more detailed or granular understanding of the various objects within a given image. In this regard, instead of processing an entire image—i.e., a large collection of pixels, many of which might not contain useful information—image segmentation may involve dividing an image into segments (e.g., into groups of pixels containing similar attributes) that may be analyzed independently or in parallel to obtain a more detailed representation of the object or objects in an image. This may be referred to herein as “mask R-CNN” and the like, as opposed to a regular R-CNN architecture. For example, mask R-CNN may be based on fast R-CNN which is slightly different from R-CNN. For example, R-CNN first applies a convolutional neural network (“CNN”) and then allocates it to zone recommendations on the conv5 property map instead of the initially split into zone recommendations. In addition, according to example embodiments, standard CNN may be used to obtain, identify, or detect any other qualitative or quantitative data related to one or more objects or regions within the one or more images. In addition, a K-means algorithm may be used.

According to still other embodiments, the image recognition process may use any other suitable neural network process while remaining within the scope of the present subject matter. For example, the step of analyzing the one or more images may include using a deep belief network (“DBN”) image recognition process. A DBN image recognition process may generally include stacking many individual unsupervised networks that use each network's hidden layer as the input for the next layer. According to still other embodiments, the step of analyzing one or more images may include the implementation of a deep neural network (“DNN”) image recognition process, which generally includes the use of a neural network (computing systems inspired by the biological neural networks) with multiple layers between input and output. Other suitable image recognition processes, neural network processes, artificial intelligence analysis techniques, and combinations of the above described or other known methods may be used while remaining within the scope of the present subject matter.

In addition, it should be appreciated that various transfer techniques may be used, but use of such techniques is not required. If using transfer techniques learning, a neural network architecture may be pretrained such as VGG16/VGG19/ResNet50 with a public dataset then the last layer may be retrained with an appliance-specific dataset. In addition, or alternatively, the image recognition process may include detection of certain conditions based on comparison of initial conditions, may rely on image subtraction techniques, image stacking techniques, image concatenation, etc. For example, the subtracted image may be used to train a neural network with multiple classes for future comparison and image classification.

It should be appreciated that the machine learning image recognition models may be actively trained by the appliance with new images, may be supplied with training data from the manufacturer or from another remote source, or may be trained in any other suitable manner. For example, according to example embodiments, this image recognition process relies at least in part on a neural network trained with a plurality of images of the appliance in different configurations, experiencing different conditions, or being interacted with in different manners. This training data may be stored locally or remotely and may be communicated to a remote server for training other appliances and models. According to example embodiments, it should be appreciated that the machine learning models may include supervised and/or unsupervised models and methods. In this regard, for example, supervised machine learning methods (e.g., such as targeted machine learning) may help identify problems, anomalies, or other occurrences which have been identified and trained into the model. By contrast, unsupervised machine learning methods may be used to detect clusters of potential failures, similarities among data, event patterns, abnormal concentrations of a phenomenon, etc.

It should be appreciated that image processing and machine learning image recognition processes may be used together to facilitate improved image analysis, object detection, or to extract other useful qualitative or quantitative data or information from the one or more images that may be used to improve the operation or performance of the appliance. Indeed, the methods described herein may use any or all of these techniques interchangeably to improve image analysis process and facilitate improved appliance performance and consumer satisfaction. The image processing algorithms and machine learning image recognition processes described herein are only examples and are not intended to limit the scope of the present subject matter in any manner.

Specifically, referring now to FIG. 3, a flow diagram of one embodiment of a method 300 of operating microwave appliance 102 is illustrated in accordance with aspects of the present subject matter. In general, method 300 will be described herein with reference to the embodiments of microwave appliance 102 above with reference to FIGS. 1 and 2. However, it should be appreciated by those of ordinary skill in the art that the disclosed method 300 may generally be utilized in association with apparatuses and systems having any other suitable configuration, such as over-the-range microwave appliance, or countertop microwave appliances. In addition, although FIG. 3 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 3, at (310), method 300 may generally include initializing a cooking operation of the microwave appliance. Generally, a user may begin a cooking operation by placing one or more food items, such as the example food item 202, in a cooking chamber of an oven appliance (e.g., cooking chamber 104 of microwave appliance 102) and selecting a desired cooking mode and/or a specified temperature level of the microwave appliance. In one example, a user may select a “potato” mode, where the “potato” mode may include activating the heating assembly at a particular power level for a specified duration of time. For instance, “potato” mode may include activating the heating assembly at fifty percent (50%) power level, for the specified duration of ten minutes (10 min). Other example cooking modes may be pizza, beverage, popcorn, defrost, etc. Accordingly, initializing the cooking operation may be performed by the microwave appliance, e.g., the controller thereof, in response to one or more user inputs, such as mode selection and/or time duration input. For example, initializing the cooking operation may include receiving one or more user inputs indicative of the mode selection and/or time duration. In other words, initializing the cooking operation may include receiving one or more user inputs, and initializing the cooking operation may be performed before activating the heating assembly of the microwave appliance.

At (320), method 300 may generally include capturing a first image of the cooking chamber using the camera in response to initializing the cooking operation, or, more specifically, capturing a first image of the food item inside the cooking chamber, such as with camera 200, before activating heating assembly 168 of microwave appliance 102 for the cooking operation. For example, capturing the first image of the food item inside the cooking chamber before activating heating assembly 168 may include capturing the first image of the food item immediately after initializing the cooking operation, such as between receiving the one or more user inputs and activating heating assembly 168, e.g., after initializing the cooking operation and before activating the heating assembly. In general, food items, such as the example food item 202, may be positioned within the cooking chamber and the line of sight of the camera. Thus, a camera (e.g., camera 200) within the cabinet/cooking chamber may capture a first image of the food item placed in the cooking chamber. The camera may then transmit the captured first image (or images) to a controller, such as controller 130, or to a remote computing device, e.g., a remote server.

At (330), method 300 may generally include determining one or more characteristics of the food item from the first image. For instance, the controller may analyze the image of the food item and extract one or more characteristics relating to the food item (e.g., color, size, moisture content, ice, etc.). Using the extracted characteristic(s), the controller may reference a programmed formula, chart, or table. As an example, the controller may consult a lookup table stored within the oven appliance to determine what type of food is provided based on a comparison with the extracted characteristic(s) of the food item. For instance, a qualitative attribute of a particular characteristic may be assigned a quantitative value within the lookup table (e.g., a level of ice present from 0 to 10). Additionally or alternatively, the camera may detect various optical characteristics, such as wavelength bands, infrared emittance, and the like. Using the extracted characteristic(s), the controller may reference a programmed formula, chart, or table. As an example, the controller may consult the lookup table stored within the oven appliance to determine what type of food is provided based on a comparison with the extracted characteristic(s). For instance, a qualitative attribute of a particular characteristic may be assigned a quantitative value within the lookup table (e.g., a level of ice present from 0 to 10, a food volume estimation, etc.).

Continuing the example seen above, the selected “potato” mode may include activating the heating assembly at about fifty percent (50%) power level, for the specified duration of ten minutes (10 min), wherein the first image may be captured and analyzed, to determine that the food item to be cooked by the “potato” mode has a level of ice present valued at, for example, ten (10). Moreover, method 300 may further include determining a state of the food item based on the determined quantitative value. In the present example scenario, it has been determined that the food item to be cooked by the “potato” mode has a level of ice present valued at a ten (10), and as such it may be further determined that that state of the food item is frozen by the controller referencing the programmed formula, chart, or table, e.g., comparing the determined quantitative value to the lookup table. Other example states of food items may be liquid, dry, thick, etc.

At (340), method 300 may generally include adjusting the cooking operation in response to the determined one or more characteristics of the food item. In general, adjusting the cooking operation may include adjusting one or more of the specified duration and the selected mode of the cooking operation. In the present example scenario, the food item to be cooked by the “potato” mode has a level of ice present valued at a ten (10), which may be determined to be frozen, and accordingly, method 300 may adjust the cooking operation to include a defrost mode before the “potato” mode. In general, a defrost mode may operate at a power level of forty percent (40%) or less. As such, the addition of the defrost mode to the cooking operation may add overall time to the duration of the adjusted cooking operation. For example, twenty percent (20%) of the specified duration of the cooking operation may be adjusted/converted to be the defrost mode, with an additional ten percent (10%) of the specified duration added to the adjusted cooking operation. In the present example scenario, the specified duration is ten minutes (10 min) of “potato” mode, however, the adjusted cooking operation may include two minutes (2 min), i.e. twenty percent (20%) of the ten minutes (10 min), of the defrost mode and an additional one minute (1 min), i.e. ten percent (10%) of the ten minutes (10 min), for an adjusted duration of eleven minutes (11 min) total.

At (350), method 300 may generally include performing the adjusted cooking operation. Thus, the actual operation which is ultimately performed by the cooking appliance in such embodiments may vary from the selected operation, e.g., may differ from the desired cooking mode and/or the specified temperature level indicated by the input from (310). For example, as noted above, the adjusted cooking operation may include two minutes (2 min) of the defrost mode followed by nine minutes (9 min) of the “potato” mode for the adjusted duration of eleven minutes (11 min) total. Accordingly, the adjusted cooking operation may advantageously improve the cooking performance of the microwave appliance in contrast to the cooking operation before adjustment. In particular, the additional defrost cycle may allow for even heating/cooking of frozen foods that may not have been thawed-out otherwise.

In some example embodiments, method 300 may include capturing a second image of the food item(s). For instance, the second image may be captured after a predetermined amount of time has elapsed in the adjusted cooking operation. For example, after the adjusted cooking operation has transpired for a predetermined amount of time, the camera may capture a second image of the cooking chamber (e.g., cooking chamber 166). In particular, the predetermined time or frequency may be set by a user or may be preset during manufacturing. For example, the predetermined frequency/time may be five minutes (5 min) or less, such as three minutes (3 min) or less, such as one minute (1 min) or less, etc. Additionally or alternatively, the camera may capture a plurality of sequential images at the predetermined frequency. In general, each image captured by the camera may be transmitted to the controller.

Moreover, method 300 may include determining updates for the one or more characteristics relating to the food item (e.g., color, size, doneness, moisture content, level of ice present, etc.) from the second image. In particular, updates for the one or more characteristics may include determining new qualitative attributes of the particular characteristic, which may be assigned a new quantitative value. In some example embodiments, the one or more characteristics of the food item from the first image may be compared to the second image. For instance, method 300 may include comparing a change in the one or more characteristics of the food item from the first image to the second image. Specifically, the controller may compare the food item in the first image to the food item in the second image. For example, method 300 may compare the level of ice present in the food item between the first image and the second image and determine the assigned quantitative value from the determined qualitative attribute. The method may consult stored data pertaining to the particular food item and analyze a cooking progress based on the change in the one or more characteristics.

Moreover, method 300 may include adjusting the adjusted cooking operation in response to the determined updates for one or more characteristics of the food item. For example, the adjusted cooking operation may include two minutes (2min) of the defrost mode followed by nine minutes (9 min) of the “potato” mode for the adjusted duration of eleven minutes (11 min) total, however, after one minute (1 min) of the defrost mode, controller may determine, from the second image, an updated level of ice present in the food item is zero (0). Accordingly, the defrost mode may be terminated one minute (1 min) early and the nine minutes (9 min) of the “potato” mode may commence, for the adjusted duration of ten minutes (10 min) total.

As may be seen from the above, a microwave appliance may automatically detect when a frozen food item is placed therein and adjust to a defrost cycle before switching to the selected cooking operation. The defrost mode may be activated for an initial twenty percent (20%) of the total cooking duration set by the user. Additionally, ten percent (10%) may be added to the total cooking duration. This may advantageously allow time for frozen food items to properly thaw before the selected cooking operation begins.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method of operating a cooking appliance, the cooking appliance comprising a cabinet defining a cooking chamber, a heating assembly, a camera, and a controller in operable communication with the heating assembly and the camera, the method comprising:
initializing a cooking operation of the cooking appliance;
capturing a first image of a food item inside the cooking chamber using the camera in response to initializing the cooking operation;
determining one or more characteristics of the food item from the first image;
adjusting the cooking operation in response to the determined one or more characteristics of the food item; and
performing the adjusted cooking operation.

2. The method of claim 1, further comprising:
capturing a second image of the food item inside the cooking chamber using the camera;
determining updates for the one or more characteristics of the food item from the second image; and
adjusting the adjusted cooking operation in response to the determined updates for the one or more characteristics of the food item.

3. The method of claim 2, wherein capturing the first image of the food item and the second image of the food item occurs at a specified frequency.

4. The method of claim 1, wherein determining one or more characteristics of the food item from the first image comprises determining a quantitative value of the one or more characteristics of the food item.

5. The method of claim 4, further comprising determining a state of the food item based on the determined quantitative value.

6. The method of claim 5, wherein determining the state of the food item based on the determined quantitative value comprises comparing the determined quantitative value to a lookup table.

7. The method of claim 1, wherein initializing a cooking operation of the cooking appliance comprises activating the heating assembly in a selected mode for a specified duration, wherein adjusting the cooking operation comprises adjusting one or more of the specified duration and the selected mode of the cooking operation.

8. The method of claim 1, wherein the one or more characteristics of the food item comprises a color, a size, and a moisture content.

9. The method of claim 1, wherein the heating assembly comprises a magnetron, the cooking operation further comprises emitting microwaves from the magnetron into the cooking chamber during the cooking operation.

10. A cooking appliance, comprising:
a cabinet defining a cooking chamber;
a heating assembly positioned in the cabinet;
a camera positioned in the cabinet; and
a controller in operable communication with the heating assembly and the camera, the controller configured to:
initialize a cooking operation of the cooking appliance;
capture a first image of a food item inside the cooking chamber using the camera in response to initializing the cooking operation;
determine one or more characteristics of the food item from the first image;
adjust the cooking operation in response to the determined one or more characteristics of the food item; and
perform the adjusted cooking operation.

11. The cooking appliance of claim 10, wherein the controller is further configured to:
capture a second image of the food item inside the cooking chamber using the camera;
determine updates for the one or more characteristics of the food item from the second image; and
adjust the adjusted cooking operation in response to the determined updates for the one or more characteristics of the food item.

12. The cooking appliance of claim 11, wherein capturing the first image of the food item and the second image of the food item occurs at a specified frequency.

13. The cooking appliance of claim 10, wherein, when determining one or more characteristics of the food item from the first image, the controller is further configured to determine a quantitative value of the one or more characteristics of the food item.

14. The cooking appliance of claim 13, wherein the controller is further configured to determine a state of the food item based on the determined quantitative value.

15. The cooking appliance of claim 14, wherein, when determining the state of the food item based on the determined quantitative value, the controller is further configured to compare the determined quantitative value to a lookup table.

16. The cooking appliance of claim 11, wherein initializing a cooking operation of the cooking appliance comprises the controller configured to activate the heating assembly in a selected mode for a specified duration, wherein adjusting the cooking operation comprises the controller configured to adjust one or more of the specified duration and the selected mode of the cooking operation.

17. The cooking appliance of claim 10, wherein the one or more characteristics of the food item comprises a color, a size, and a moisture content.

18. The cooking appliance of claim 10, wherein the heating assembly comprises a magnetron, the cooking operation further comprises emitting microwaves from the magnetron into the cooking chamber during the cooking operation.
